(19) United States
(12) Patent Application Publication
(10) Pub. No.: US 2007/0069979 A1
(43) Pub. Date: Mar. 29, 2007

(54) Dishwasher with a display device

(76) Inventors: Michael Rosenbauer, Reimlingen (DE); Bernd Schessl, Dillingen/Donau (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(21) Appl. No.: 10/575,302

(22) PCT Filed: Oct. 21, 2004
(86) PCT No.: PCT/EP04/52612

§ 371 Date: Apr. 11, 2006

(30) Foreign Application Priority Data
Oct. 27, 2003 (DE) 10350077.4

(51) Int. Cl. G09G 3/00

(52) U.S. Cl. 345/32

(57) ABSTRACT

A dishwasher with a display device that uses a display surface in order to display a plurality of information and light means in order to display different colors is provided. The light means produces a light beam that is directed to at least one display surface, wherein at least one color filter disk is arranged in the beam path of the light beam produced by the light means, the disk determining the color of the light beam. Based on the selection of the color filter disk, different colors can be produced and different types of information can be reproduced on the display surface, for instance, information on the manufacturer or range of products of the dishwasher in question without having to modify the display device.

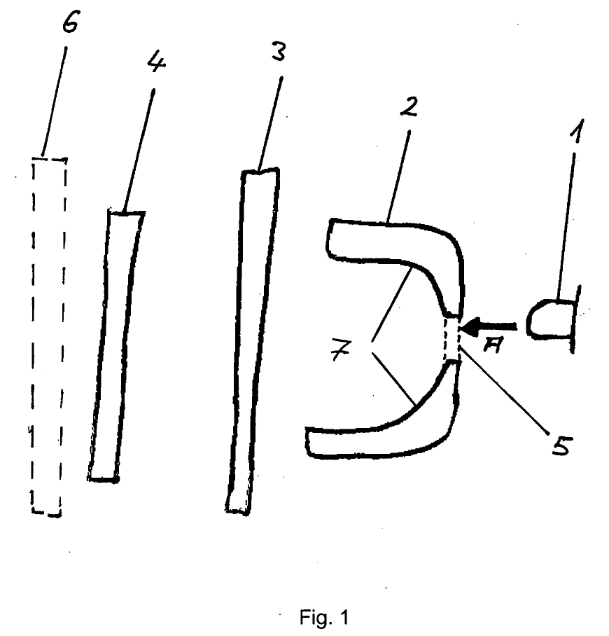

The invention relates to a dishwasher with a display device for visible display of information, such as for example the need for refilling of detergents or rinse aids or the make of the dishwasher.

Dishwashers with display devices are already known which are used for the visible reproduction of information such as, for example, the actual status of the washing program or the level of detergent, rinse aid of other means necessary for the operation of the dishwasher. The known dishwashers usually comprise a plurality of display devices each provided for the display of certain information. For this purpose the display surfaces are equipped with a light means which illuminates the respective display surface when the relevant information is to be displayed.

The display devices according to the prior art have the disadvantage that a plurality of display surfaces are required to display a plurality of information. The known display devices further have the disadvantage that different light means must be used for the reproduction of different colours.

It is thus the object of the present invention to eliminate the aforesaid disadvantages and provide a dishwasher with a display device which can display a plurality of information using one display surface and can represent different colours using one light means.

This object is solved by the dishwasher according to the invention with the features according to claim 1. Advantageous further developments of the present invention are characterised in the dependent claims 2 to 10.

Provided in the dishwasher according to the invention is an optical display device which has light means for producing a light beam which is directed onto at least one display surface, wherein at least one colour filter disk is arranged in the beam path of the light beam produced by the light means, said disk determining the colour of the light beam.

The dishwasher according to the invention has the advantage that during the manufacture of the dishwasher filter disks of different colours can be arranged in the beam path of the light beam produced by the light means, which disks produce different colours on the display surface. Since different makes or product series of dishwashers are identified by means of different colours, for example, different information on the manufacturer or the product series of the dishwasher concerned can thus be reproduced on the display surface by selecting the colour filter disks without the display needing to be changed otherwise. It is additionally possible that information is given on the display surface itself, such as for example, the name of the manufacturer or the model designation of the dishwasher, where the display surface of the display device is still back-lit during operation.

A further advantage of the dishwasher according to the invention is that substantially the same display device can be used in dishwashers of different product series since different colours can be produced on the display surface by selecting a filter disk with the corresponding colour. In particular, in dishwashers of different product series according to the invention, the same light means can be used since the colour of the display surface is determined by selecting the colour filter disk.

In a particularly advantageous embodiment of the present invention, at least one filter disk is preferably exchangeably arranged in the beam path of the light beam produced by the light means between the light means and the display surface. Alternatively, a preferably exchangeable arrangement of the filter disk in relation to the direction of the light beam produced by the light means behind the display surface is possible. Both arrangements have the effect that the user of the dishwasher according to the invention is offered an appearance of the display surface which lights up during operation in the colour determined by the filter disk. The exchangeable arrangement of the colour filter disk before or behind the display 27, 2003 surface makes it possible for the filter disk to be exchanged or replaced subsequently after the manufacture of the dishwasher.

More appropriately, the display surface is made at least partly of a transparent, preferably matt-finished material since such a material makes the reproduction of information applied to the display surface and the back lighting of the display surface particularly effective.

It is particularly advantageous if the light means of the display device is a light-emitting diode which preferably produces white light. A light-emitting diode is distinguished by low current consumption on the one hand and by a low liability to breakdown on the other hand. The use of a light means that produces white light has the advantage that the colour appearance of the display surface is identically determined by the choice of coloured filter disk.

In a further embodiment of the present invention, a mask is preferably exchangeably arranged in the beam path of the light beam produced by the light means, its silhouette being projected by the light beam onto the display surface. The light beam produced by the light means can be influenced by the arrangement of a mask with a specific silhouette in the beam path in order to project a company logo on the display surface, for example. In this way however, other information can be displayed on the display surface without the display surface itself needing to have lettering. Furthermore, substantially the same display device can be used in dishwashers of different product series since different information can be displayed on the display surface by selecting a mask with the corresponding silhouette. As a result of the exchangeable arrangement of the mask, this can be exchanged or replaced subsequently after manufacture of the dishwasher.

In a further embodiment of a dishwasher with a display device according to the present invention, the display surface is embodied as a liquid crystal display which is divided into a number of segments whose transparency and/or colour is individually variable by an externally applied electric voltage. The use of such a liquid crystal display makes it possible to display information of any kind on the display surface where the number and diversification of the information depends on the arrangement and size of the segments into which the liquid crystal display is divided. In this case, it is especially advantageous if the individual segments of the liquid crystal display are controlled individually, preferably electronically, by the program control of the dishwasher. As a result of the back lighting of the liquid crystal display by means of the display device according to the invention, the display surface can be additionally illuminated in different colours and at different intensity.

The intensity of the back lighting by the display device according to the invention can be further increased if a light shaft is arranged in the beam path of the light beam produced by the light means which has a reflecting surface on its side facing the light beam. In addition, the light shaft can be constructed so that it focuses the light beam produced by the light means and at least partly reflects it in the direction of the display surface.

The present invention is explained in detail hereinafter using an exemplary embodiment with reference to the appended drawing. The appended drawing shows a schematic diagram of a display device such as is used for example in a dishwasher according to the present invention.

The display device shown in the drawing comprises a light-emitting diode 1 which produces a white light beam which is directed onto a display surface 4 in the direction of the arrow A. The light beam passes through an opening in a light shaft 2 which has a reflecting surface on its side facing the light beam. The reflecting surface of the light shaft 2 is further constructed in a spherical form so that it focuses the light beam produced by the light-emitting diode 1 and reflects at least partly in direction A towards the display surface 4. A coloured filter disk 3 which determines the colour of the light beam is exchangeably arranged in the beam path of the light beam produced by the light-emitting diode 1 on the path to the display surface 4.

Alternatively or additionally to positioning the filter disk 3 between the light-emitting diode 1 and the display surface 4, a filter disk 6 can also be placed behind the display surface in relation to the direction A of the light beam generated by the light-emitting diode 1. Both arrangements have the effect that during operation of the display device, the display surface 4 lights up in the colour determined by the filter disk 3, 6. As a result of the exchangeable arrangement of the filter disk 3, this can also be exchanged or replaced subsequently during the manufacture of the dishwasher without needing to otherwise vary the display device.

In addition to or instead of the filter disk, a mask 3 can be exchangeably arranged in the beam path of the light beam produced by the light-emitting diode 1, its silhouette being projected by the light beam onto the display surface 4. The arrangement of the mask 3 with a certain silhouette can influence the light beam produced by the light-emitting diode 1 so that, for example, a company logo or a symbol for the actual status of the washing program is projected on the display surface 4. As a result of the exchangeable arrangement of the mask 3, this can also be exchanged or replaced subsequently during the manufacture of the dishwasher without needing to otherwise vary the display device.

A third possibility for arranging a coloured filter disk or mask is the position in the opening 5 of the light shaft 2 through which the light beam produced by the light-emitting diode 1 in the direction of the arrow A is incident. The arrangement of a coloured filter disk or mask in the opening 5 of the light shaft 2 has the advantage that it is positioned closer to the light means 1 than in the arrangement 3, 6 before or after the display surface 4 described above. As a result of the arrangement near the light-emitting diode 1, the coloured filter disk or the mask can be constructed smaller in the opening 5 of the light shaft 2.

The display surface 4 is made of a partly transparent, preferably matt-finished material whereby the reproduction of information applied to the display surface and the back lighting of the display surface is particularly effective. In the embodiment shown in the drawing the display surface 4 is constructed as a liquid crystal display 4 which is divided into a number of segments (not shown) whose transparency and/or colour can be varied individually by an externally applied electric voltage. By using a liquid crystal display 4 as the display surface 4, information of any type allowed by the size and segmentation of the liquid crystal display can be displayed on the display surface 4. For this purpose the segments of the liquid crystal display 4 are individually controlled electronically by the program control (not shown) of the dishwasher. As a result of the back lighting of the liquid crystal display 4 by means of the display device according to the invention, the display device 4 can be illuminated in different colours and at different intensities.

### REFERENCE LIST

1 Light means or light-emitting diode
2 Light shaft
3 Filter disk or mask
4 Display surface or liquid crystal display
5 Filter disk or mask
6 Filter disk
7 Spherically constructed, reflecting surface of the light shaft 2
A Direction of light beams

1-10. (canceled)

11. A dishwasher comprising:
a program control that controls washing operations in a washing container in which items to be washed are disposed; and
an optical display device having means for producing a light beam whose beam path can be directed onto a display surface; and
at least one color filter disk arranged in the beam path of the light beam produced by the light means, wherein the color of the light beam directed onto a display surface is influenced by the at least one color filter disk.

12. The dishwasher according to claim 11, wherein the at least one color filter disk is arranged between the light means and the display surface relative to the beam path of the light beam produced by the light means with the at least one color filter disk being a selected one of an exchangeable at least one color filter disk that can be exchanged out of its location in the beam path of the light beam such that a selected one of another color filter disk and no color filter disk can be provided in lieu of the exchanged-out at least one color filter disk and a non-exchangeable at least one color filter disk adapted to remain in its location in the beam path of the light beam without exchange thereof for a selected one of another color filter disk and no color filter disk.

13. The dishwasher according to claim 11, wherein the at least one color filter disk is arranged behind the display surface relative to the beam path of the light beam produced by the light means with the at least one color filter disk being a selected one of an exchangeable at least one color filter disk that can be exchanged out of its location in the beam path of the light beam such that a selected one of another color filter disk and no color filter disk can be provided in lieu of the exchanged-out at least one color filter disk and a non-exchangeable at least one color filter disk adapted to remain in its location in the beam path of the light beam without exchange thereof for a selected one of another color filter disk and no color filter disk.

14. The dishwasher according to claim 11 and further comprising a display surface, the display surface at least partially comprising a transparent surface that is a selected one of a matt-finished surface and a non-matt-finished surface.

15. The dishwasher according to claim 14, wherein the display surface is a liquid crystal display that is divided into a number of segments having transparency and color properties at least one of which is individually variable via the application of an externally applied electric voltage to the liquid crystal display.

16. The dishwasher according to claim 15, wherein the individual segments of the liquid crystal display are controlled individually by the program control of the dishwasher in a selected one of an electronic manner and a non-electronic manner.

17. The dishwasher according to claim 11, wherein a mask is arranged in a selected one of an exchangeable manner and a non-exchangeable manner in the beam path of the light beam produced by the light means, with a silhouette of the mask being projected by the light beam onto the display surface.

18. The dishwasher according to claim 11 and further comprising a light shaft is arranged in the beam path of the light beam produced by the light means, the light shaft having a reflecting surface on a side thereof facing the light beam.

19. The dishwasher according to claim 18, wherein the light means is configured to focus the light beam produced by the light means and at least partly reflects it in the direction of the display surface.

20. The dishwasher according to claim 18, wherein the light means is a light-emitting diode that produces a selected one of white light and non-white light.
